(19) United States
(12) Patent Application Publication
(10) Pub. No.: US 2011/0204064 A1
(43) Pub. Date: Aug. 25, 2011

(54) COMPRESSED GAS STORAGE UNIT

(75) Inventors: Stephen E. CRANE, Santa Rosa, CA (US); Ever J. BARBERO, Morgantown, WV (US)

(73) Assignee: LightSail Energy Inc., Oakland, CA (US)

(21) Appl. No.: 13/050,442

(22) Filed: Mar. 17, 2011

Related U.S. Application Data
(60) Provisional application No. 61/347,321, filed on May 21, 2010.

(51) Int. Cl. F17C 1/02

(52) U.S. Cl. 220/592

(57) ABSTRACT

Embodiments of the present invention relate to compressed gas energy storage systems exhibiting one or more desirable characteristics. Certain embodiments of such systems may be efficient (80% round-trip), cost-effective (system cost <$100 kWh), and/or quickly rampable (<10 minutes). Particular embodiments may use water sprays to facilitate heat transfer at high pressures during compression and expansion. The use of gas storage units of a filament-wound design, may significantly reduce the cost of gas storage.

### CROSS-REFERENCE TO RELATED APPLICATION(S)

The instant nonprovisional patent application claims priority to U.S. Provisional Patent Application No. 61/347,321, filed May 21, 2010 and incorporated by reference in its entirety herein for all purposes.

### GOVERNMENT RIGHTS

Not Applicable

### BACKGROUND

Air compressed to 300 bar has energy density comparable to that of lead-acid batteries and other energy storage technologies. However, the process of compressing and decompressing the air typically is inefficient due to thermal and mechanical losses. Such inefficiency limits the economic viability of compressed air for energy storage applications, despite its obvious advantages.

It is well known that a compressor will be more efficient if the compression process occurs isothermally, which requires cooling of the air before or during compression. Patents for isothermal gas compressors have been issued on a regular basis since 1930 (e.g., U.S. Pat. No. 1,751,537 and U.S. Pat. No. 1,929,350). One approach to compressing air efficiently is to effect the compression in several stages, each stage comprising a reciprocating piston in a cylinder device with an intercooler between stages (e.g., U.S. Pat. No. 5,195,874). Cooling of the air can also be achieved by injecting a liquid, such as mineral oil, refrigerant, or water into the compression chamber or into the airstream between stages (e.g., U.S. Pat. No. 5,076,067).

Several patents exist for energy storage systems that mix compressed air with natural gas and feed the mixture to a combustion turbine, thereby increasing the power output of the turbine (e.g., U.S. Pat. No. 5,634,340). The air is compressed by an electrically-driven air compressor that operates at periods of low electricity demand. The compressed-air enhanced combustion turbine runs a generator at times of peak demand. Two such systems have been built, and others proposed, that use underground caverns to store the compressed air.

Patents have been issued for improved versions of this energy storage scheme that apply a saturator upstream of the combustion turbine to warm and humidify the incoming air, thereby improving the efficiency of the system (e.g., U.S. Pat. No. 5,491,969). Other patents have been issued that mention the possibility of using low-grade heat (such as waste heat from some other process) to warm the air prior to expansion, also improving efficiency (e.g., U.S. Pat. No. 5,537,822).

### SUMMARY

Embodiments of the present invention relate to compressed gas energy storage systems exhibiting one or more desirable characteristics. According to certain embodiments, such systems may be efficient (80% round-trip), cost-effective (system cost <$100 kWh), and/or quickly rampable (<10 minutes). Particular embodiments may use water sprays to facilitate heat transfer at high pressures during compression and expansion. The use of gas storage units of a filament-wound design, may significantly reduce the cost of gas storage.

### BRIEF DESCRIPTION OF THE FIGURES

FIG. 1 shows a model of jet breakup from a two-dimensional computational flow dynamics (CFD) simulation.

FIG. 2. shows CFD simulation of water spray emitted from a nozzle design.

FIG. 3 shows CFD simulation of water spray emitted from pyramid nozzle.

FIG. 4a shows liquid sheet breakup & atomization from an embodiment of a nozzle. FIG. 4b shows droplet size distribution from an embodiment of a nozzle.

FIG. 5a indicates the mass-average air temperature in cylinder (K) versus crank rotation from CFD simulations with and without splash model. FIG. 5b indicates the temperature (K) immediately preceding opening of exhaust valve.

FIG. 6A shows a simplified view one embodiment of a compressed gas storage unit according to the present invention.

FIG. 6B shows another embodiment of a compressed gas storage unit in accordance with the present invention.

FIG. 6C shows yet another embodiment of a compressed gas storage unit in accordance with the present invention.

FIG. 6D shows still another embodiment of a compressed gas storage unit in accordance with the present invention.

FIG. 7A shows a side elevational view of a configuration utilizing a vertical folded configuration for pressure vessels.

FIG. 7B shows a plan view of a configuration utilizing a serpentine horizontal folded configuration for pressure vessels.

FIG. 8 shows a simplified view of an embodiment of an energy storage system.

FIG. 9 shows a simplified view of an alternative embodiment of an energy storage system.

FIG. 9A shows various basic operational modes of the system of FIG. 9.

FIGS. 9BA-BF show simplified views of the gas flow paths in various operational modes of the system of FIG. 9.

FIG. 10 shows tensile strengths of various steel music wires.

FIG. 10A shows the chemical composition of certain embodiments of steel music wire.

FIGS. 11A-N show various possible cross-sections of wire and/or filler material.

### DESCRIPTION

Efficient, cost-effective energy storage technology according to embodiments of the present invention uses compressed air as the storage medium. Unlike existing compressed air energy storage technology (CAES), embodiments of the present invention can be sited anywhere, are highly efficient, and need no fossil fuels to operate.

Embodiments according to the present invention offer the ability to compress and expand air nearly isothermally. Isothermal operation greatly improves efficiency, but it has proven difficult to achieve previously, particularly at high power densities. Embodiments of the present invention inject a water spray directly into the compressing or expanding air. This absorbs the heat of compression, reducing the required work (and adds heat during expansion, increasing the work retrieved). A near-constant operating temperature allows operation at higher compression ratios and higher speeds, lowering costs; and it eliminates the need to burn fossil fuels during expansion.

Though conceptually simple, water-spray facilitated heat transfer represents a significant engineering challenge—particularly at high pressures. Embodiments in accordance with the present invention may transfer heat out of a compression chamber (and into the expansion chamber) at rates up to ten times higher than have ever been reported in the scientific literature.

Embodiments according to the present invention relate to practical utility-scale energy storage that uses compressed air as the storage medium. Our proposed technology can be sited anywhere, is highly efficient, and needs no fossil fuels to operate.

A focus of embodiments according to the present invention is the ability to compress and expand air nearly isothermally. Isothermal compression greatly improves efficiency, but it has proven difficult to achieve, particularly at high power densities. One approach according to embodiments of the present invention is to spray water droplets directly into the compression and expansion chambers to facilitate heat exchange.

Another approach relates to gas storage. In particular, use of a novel composite design may significantly reduce the cost of storage tanks.

Several tasks are employed to demonstrate this technology at a commercial scale. Analysis and modeling can be used to refine and extend mathematical models of the thermodynamic, mechanical, acoustic, and hydraulic processes occurring in the system.

The fluid dynamics of water sprays can also be modeled. Examples include flow through nozzles, droplet breakup, collisions with the cylinder walls, and two-phase flow with air.

Development of a compressor can proceed as follows. A 100 kW-scale gas compressor can be modified to operate reversibly as an expander and integrate water-spray facilitated heat transfer. A single stage may be prototyped at low pressure (300 psi), then add a second stage to reach 3000 psi or higher. A pre-mixing chamber and custom valves for the second stage may be designed to enable high volume fraction of water at high pressures.

Tank construction can proceed as follows. The winding of fibers and wires on a low-cost liner may be simulated. A small scale prototype may be built and tested. In particular, such simulation and prototyping may relate to various winding strategies and matrices. Tanks capable of holding one cubic meter of air at 200+ atmospheres (3000 psi), can be built.

Existing Grid-Scale Energy Storage Technology

Grid energy storage is dominated today by two technologies, pumped hydro and compressed air (CAES). These technologies operate via the transport or compression of two fluids: air and water. Air and water will always be extremely inexpensive. A challenge is in making the systems that use them efficient, scalable, and flexible.

Embodiments in accordance with the present invention relate to energy storage technology that uses compressed air as the storage medium. Compressed air may offer the best opportunity for cost-effective grid-scale energy storage—potentially meeting cost targets of <$100/kWh.

Existing compressed air energy storage (CAES) uses a compressor turbine, operated by an electric motor, to compress air. In the systems implemented to date, the compressed air is stored underground in a salt dome until it is needed. The compressed air is used to operate an expansion turbine during power delivery.

However, because the air cools so much during expansion, limiting the amount of energy that can be obtained, natural gas is burned to heat the air stream before it enters the expansion turbine. This is essentially a natural gas combustion turbine operated with a time delay between compression and expansion.

Although two CAES systems are in operation, they have not proven to be popular technology due to expense and efficiency considerations, and the requirement of fossil fuel combustion to operate.

Near-Isothermal Compressed Air Energy Storage

Several projects are underway that propose to address the disadvantages of existing CAES systems. The objective is to develop compressed air energy storage that delivers power exclusively from air expansion without the need for supplementation with fossil fuel combustion.

This new compressed air technology uses near-isothermal (rather than adiabatic) compression and expansion. It is a basic result in thermodynamics (see the Preliminary Results section below) that less work is required to compress a gas if the heat generated during compression is removed from the system during the compression stroke. Similarly, if heat is added during expansion, more power will be generated.

If the temperature is kept constant during operation, the efficiency of energy storage can, in theory, approach 100%. In fact, there are many sources of possible losses—friction, pressure drops, electrical-mechanical conversion losses, etc. Nevertheless, a round-trip efficiency approaching 80% may be achievable.

There are several approaches to achieving near-isothermal performance, with heat transferred out of the compression chamber during compression and added during expansion. This can be done by operating very slowly, so that there is time for the heat to conduct through the walls of the chamber. Such a system may have difficulty scaling, and may run slowly, limiting the system's power density (and therefore increasing its cost).

Alternatively, a heat exchanger can be incorporated into the compression chamber, and this approach has been used by Lemofouet, S., “Energy Autonomy and Efficiency through Hydro-Pneumatic Storage”, http://www.petitsdejeunersvaud.ch/fileadmin/user_upload/Petits_dejeuners/EnAirys_Powertech_{—}20081121.pdf.

Water-Spray Mechanism for Near-Isothermal Air Compression and Expansion

Embodiments according to the present invention may take yet a different approach. Specifically, a liquid with high heat capacity (such as water) is sprayed into the air during compression and expansion. Because the water can absorb so much more heat per unit volume than the air, a small amount is sufficient to keep the process near-isothermal. And because water sprays provide such a large surface area for heat exchange, large amounts of heat can be transferred very quickly.

Such liquid injection according to embodiments of the present invention, will allow the compressor/expander mechanism to run at high RPM's. The faster the system runs, the more power it can deliver for a given system cost.

Mechanical components should be capable of high-speed operation in order to take full advantage of the heat transfer capabilities of water sprays. However, previous known technology for near-isothermal air compression uses hydraulic cylinders and a hydraulic motor/pump to deliver power. Use of hydraulics, though simple to prototype, significantly limits the speed of operation. At the scale of interest here, a mechanical system—for example using reciprocating pistons and a crankshaft according to embodiments of the present invention—can operate much faster than a hydraulic circuit.

The problem of water-spray facilitated heat exchange gets harder at high pressures, however—and high pressures may be important to obtain high efficiency and a small air-storage footprint. Accordingly, embodiments of the present invention may use a higher volume fraction of water-to-air than has been reported to date in the scientific literature in order to keep compression near-isothermal at a target pressure of 200 atmospheres. This may involve the design of specialized nozzles, valves, and spray manifolds to achieve spray density and uniformity.

Embodiments of the present invention may use reciprocating mechanical pistons, much like an automobile engine. Mechanical piston designs employing a crankshaft, bearings, and a lubrication system, may be more difficult to engineer than hydraulic designs. However, for this application, embodiments according to the present invention may achieve ten times the operating speed of hydraulics for the same displacement. Such systems can therefore deliver considerably more power for a comparable cost; air compressors and automotive engines use reciprocating pistons rather than hydraulics for this reason. The added complexity of a reciprocating mechanism allows leveraging full advantage of the heat transfer capabilities of water spray.

Some of the cost of a compressed air energy storage system, is associated with the air storage tanks. This is particularly true if several hours of storage are desired.

Existing CAES facilities use underground geological features for their air storage. If available, this may continue to be the lowest cost solution for large-scale (>10 MW) systems.

However, it is desirable to be able to site energy storage in arbitrary locations that may not have appropriate geology. In such a case, conventional cylindrical steel gas storage vessels may be used for above-ground storage.

Although steel gas storage cylinders are a mature and ubiquitous technology, and may work for this application. However, it may not be possible to achieve a goal of $100 kWh using such cylinders. Even large cylinders intended for natural gas storage obtainable from overseas suppliers cost closer to $150 kWh when used to store compressed air.

Other forms of steel containers have been proposed. A natural gas pipeline pipe is one possibility, and oil well casing pipe is another. But, ultimately, the cost of these solutions is driven by the cost of steel.

According to embodiments of the present invention, alternative designs for compressed gas storage units may be used. Particular embodiments utilize a filament-wound tank and a geometry tailored to this application.

Filament wound pressure vessels have a widespread use. They are typically wound over a liner with carbon or glass fibers. The result is a very light tank.

The motivation to use a liner is to assure that the vessel will not leak if the polymer matrix that binds the fibers together experiences micro or macro cracking. One possible drawback of using a liner is that the maximum stress that the fibers can bear is limited by the yield strain of the liner. If the liner is made of steel or aluminum, the yield strain of the liner may be about 0.2%, while the ultimate strain of the reinforcement fibers may be in the range of 1.5-4.4%.

Even if the liner is pre-stressed, the limiting strain can at most be doubled to 0.4%. If a low modulus (low cost) fiber like E-glass is used, less than the 10% of its strength can be exploited. One approach uses stiffer fibers like high modulus carbon fiber, but the cost of fibers grows exponentially with their modulus.

Embodiments according to the present invention may use low-cost fibers, whose strength is fully employed. In certain embodiments, this is done avoiding the use of a metallic liner.

Such approaches could allow one or more of the following possibilities. In certain embodiments, a matrix with a lower ultimate strain than the fiber's could be used. This would permit the matrix to crack, leading to two options.

In one option, a small amount of leakage is allowed due to matrix cracking. As the leaking air is not hazardous, this should not cause problems except to slightly reduce the system's efficiency.

Another option is to use a thin bladder (which can be made from a rubber-like material), or to coat the vessel with a high strain, impermeable coating. This improves efficiency but adds cost.

Another possibility is to use a matrix with a higher ultimate strain than the fiber's elongation. This would allow maximizing the use of the fibers strength, but with a higher cost of the matrix.

One factor to consider is the choice of fiber and matrix. Two fiber choices that could be prototyped as part of this study are: basalt (a relatively new material), and high-tensile strength steel wire. Because of basalt fiber's high stiffness, it could be used with an inexpensive matrix such as isophthalic polyester. The steel alloy wire, sold under the trade name SCIFER, has tensile strengths as high as 5500 MPa for small fibers—10 to 20 times that of high-strength steel. Either fiber choice offers the possibility of a substantial reduction in tank costs.

Another consideration is tank geometry. Traditional (lined) pressure vessels are typically wound on a compact end geometry, because of space restrictions or to minimize the material cost of the liner. In the instant application, there is no penalty for vessel length and the liner is a low-cost bladder. Accordingly, an isotensoid geometry which minimizes fiber usage may be desirable.

The fiber may be wound at an angle of 55 degrees. With this angle it may be difficult to cover the ends of the vessel down to the boss (the vessel opening).

In conventional pressure vessels, significant material and process cost may be incurred to cover the ends with suboptimal angles. Particular embodiments according to the present invention can avoid this by fitting vessels with large bosses that match the diameter that can be covered by a 55-degree winding. The bosses can have flanges allowing connection of several vessels end to end. The openings on the first and last vessel in the sequence will be covered by a steel end cap.

Codes of practice may allow substituting knowledge of localized stress and testing in place of large safety factors. Detailed stress analysis, testing, and probabilistic methods can be employed in place of large safety factors, thus maximizing safety while minimizing overdesign. Embodiments in accordance with the present invention employing a new type of tank design using composite technology, may be substantially lower in cost than conventional steel tanks.

Embodiments of the present invention may relate to an efficient energy storage system that can ramp up quickly (for example 1 minute or less) and deliver over 20 kW of power for at least an hour. A prototype system is a commercial reciprocating compressor, modified to operate near-isothermally at pressures of up to 200 atmospheres. Conventional compressors typically operate at lower pressures (about 3.5 atmospheres). Tanks constructed to store the high-pressure compressed air may be of a novel composite design.

Compressor/Expander

In order to create a thermodynamic model for the entire air compression/expansion process, the current model described in the Preliminary Results section below, may be modified to include effects of water vapor, continuous spray, boundary layer, and turbulent mixing effects. Closed-form bounds for the system behavior are be found, and then numerical methods may be used to determine detailed values for specific configurations and operating conditions.

In order to model water spray behavior in a cylinder with a moving piston at high pressures using computational flow dynamics (CFD), new nozzle designs (for example as described in the Preliminary Results section below) may be modeled using CFD to improve the spray density and uniformity. CFD analysis has proven useful in determining the most productive design avenues to pursue.

Nozzle manifolds in cylinder models may be modeled across the range of bore/stroke ratio and pressures of interest. Models of spray systems at high pressures—100 atmospheres and above—may be of particular value to reflect high spray densities that are to be achieved.

A separate set of CFD models can be run to simulate the flow in and out of valves. Optimizing valve flow may improve volumetric efficiency. Another consideration in valve design is to ensure that water droplets sprayed into the air stream in a pre-mixing chamber remain entrained with the air as the mixture passes through the valve orifice.

Some modeling indicates that piston motion and splashing effects may be relevant. These can be further developed, particularly at high pressures. The modeling described above can be performed, for example, using the ANSYS Fluent software package.

A spray system capable of creating a highly uniform volume fraction of water near 10% at 200+ atmospheres pressure is under development. High-pressure cylinders have small bores, so that the direct-injection design used for the low-pressure cylinders (where the nozzles spray directly into the cylinder) is likely to be impractical—there won't be room for the number of nozzles required.

A pre-mixing chamber upstream of the cylinder may be used. In such a mixing chamber, the appropriate volume fraction of water to air is generated, then passed through an intake valve to the cylinder. CFD can be used to design an effective chamber geometry and nozzle distribution.

A high flow-coefficient valve capable of allowing a dense air-water aerosol to pass through, is being developed. As mentioned above, the challenge is to move a dense air-water droplet mixture from the pre-mixing chamber into the cylinder while keeping the droplets in suspension.

Various valve geometries are possible. One is a rotating valve with a large cylindrical orifice that doesn't require the flow to change direction. A second geometry utilizes a port, or group of ports, in the cylinder wall, as can be found in many two-stroke engines.

In the second arrangement, the piston itself opens and closes the valve as it travels. One challenge with the port geometry may be to is to make it work for both compression (where the ports may be located just above the top of the piston at bottom dead center) and expansion (where the ports may be located near top dead center).

Certain embodiment may use liquid water to manage the dead volume in a cylinder. Near-isothermal compression and expansion allow high compression ratios to be achieved without the large temperature changes that would make such ratios impractical. However, a high compression or expansion ratio may be difficult to achieve unless the dead volume (the portion of the cylinder volume that remains uncovered when the piston is at top dead center) is too large. In a conventional gas compressor, for example, the dead volume is 25%, limiting the compression ratio to four.

Embodiments according to the present invention may achieve a compression ratio as high as 20 or more. This could be achieved using carefully designed piston/cylinder/valve assembly and/or by the use of water fill much of the dead space.

With the latter, the method by which just the right volume of water is maintained in the cylinder during operation may be hard to achieve. Solving this problem may involve modeling and experimentation with valve design and feedback-based control.

Embodiments of the present invention may seek to exercise optimal control of water spray in air compressor/expander. The performance (efficiency and power) of the compressor/expander may depend on timing and amount of water spray.

In general, the more water that is sprayed the better it is able to isothermalize the compression/expansion. However, water spray also incurs a cost (e.g. pressure drop).

It therefore may be useful to determine a strategy to inject the least amount of water while satisfying the goal of isothermalizing the process. An analytical model that can provide sufficient accuracy in order to determine the optimal timing and amount may not be readily available. Learning control approaches may be utilized, in which through repeated experiment, an optimal control strategy will be attained. Formally, such approaches are termed self-optimizing control or extremum seeking approaches.

Embodiments of the present invention may integrate a spray system, valves, dead-volume management system, and the spray control optimization, into a single-cylinder compressor/expander capable of a high compression ratio. A single cylinder may be configured to operate as a compressor or expander at 10 to 20 atmospheres or higher with a controllable ΔT. System performance may be characterized and compared with the analytical model.

Certain embodiments may utilize a multi-stage compressor capable of >100 atmospheres pressure. In certain embodiments the compressor/expander may be configured to work with two cylinders. According to some embodiments, the water spray system may use a higher pressure of the second stage to pump water spray through the nozzles of the lower-pressure cylinder. The heat exchanger system may be configured to support the cylinders and manage the spray system to maintain equal ΔT's in both stages.

Embodiments of a composite tank design may allow exploring the fabrication of economically feasible pressure vessels to store compressed air at high pressures such as (200+ atm or 3000+ psi). A goal of such a storage unit may be to maximize the energy that the pressure vessel will store while minimizing the total cost (including materials, labor and set up).

Various approaches to tank geometry and winding may be used. Certain embodiments may specify possible alternatives for low cost materials (steel wires, carbon fibers or other composites). The creation of certain embodiments may involve specifying the liner, binding materials, and/or fabrication processes. Fabrication of certain embodiments may involve the use of structural analysis (static and dynamic) and/or finite element analysis.

Preliminary Results

Near-Isothermal Compression and Expansion

Air is an inexpensive storage medium. Rapid heat transfer can allow efficient energy storage. Water, sprayed finely, densely and uniformly, would allow desirable heat transfer.

Water has a greater volumetric heat capacity than air (more than 3200×). So even a small volume of water suspended as spray in the compressing air, could absorb large amounts of heat of compression and likewise supply heat for expansion, without undergoing a significant temperature change.

A detailed analytical and numerical thermodynamic analysis (see below) yielded analytical upper and lower bounds for thermodynamic performance. A numerical simulation verified those bounds.

Efficient expansion of air can be achieved utilizing various approaches. While the injection of water spray could improve heat transfer, existing air motors cause significant ‘free’ expansion, which wastes the energy stored without doing any useful work.

Accordingly, certain embodiments of the present invention may utilize a ‘controlled pulse’ valve timing strategy that would recover that efficiency. This valve timing strategy would open the valves at the beginning of the expansion process for a specified time and then close the valves. This would admit enough air such that when expansion completed, the internal pressure is equal to the pressure of the lower stage or atmosphere, and all available energy extracted.

To demonstrate that: (a) a ‘controlled pulse’ valve strategy would avoid inefficiencies due to free expansion and (b) near-isothermal compression and expansion are both possible and allow efficient energy storage, a small prototype was built using the fluid piston concept. Air was displaced by a hydraulic fluid instead of a piston, without attempting to spray fluid into the air. A drive, controller board, and pressure cells were homebuilt. Using solenoid valves, a hydraulic motor, and a gallon of vegetable oil for the hydraulic fluid, an air motor was built that demonstrated thermodynamic efficiency at 88% of a perfect isothermal system.

Components, costs, and parasitic losses throughout this prototype system were hunted down and eliminated where possible. For example, it was recognized that a liquid piston or other hydraulic system would struggle to achieve high energy densities, low costs, and high efficiencies. High energy densities necessitate high RPMs, but the momentum and friction of liquid moving around so rapidly may make it difficult to build a stable, robust, efficient system. The fluid friction associated with moving such a significant amount of liquid around would reduce efficiency by a significant amount—by some estimates more than 5% each way.

In addition, during the compression and expansion the pressure could change, moving the hydraulic motor/pump continually off of its maximum efficiency point. Based upon available efficiency curves, efficiency could be reduced by, again, more than 5% each way.

Accordingly, mechanical approaches to compression and expansion may be favored, for example using a reciprocating piston in a cylinder.

Water spray could alleviate traditional technical problems, cooling all of the surfaces, reducing wear on sliding components. For example, a leading manufacturer makes compressors that cannot have a compression ratio exceeding 3.5: the high temperatures created would stress the materials too far. This limitation is avoided with the use of water spraying.

Additionally, water could access hard-to-reach crevices of the cylinder head and valve assemblies, taking up the ‘dead-volume’ that reduces the volumetric efficiency and compression ratio of compressors and engines. For example, with traditional reciprocating technology, it would take 4 stages to compress air at one atmosphere to 200 atmospheres. Embodiments according to the present invention may be able to achieve this in two stages.

Cost and inefficiency of variable frequency drives are another possible source of improvement. A synchronous motor generator with load control could instead be used, and on the compressor/expander control the valve pulse length. Such an approach could trade off some efficiency in exchange for increased or decreased power in real time.

In certain embodiments, the spray system may meet the following performance criteria: it may generate small droplets (<100 micron) at a relatively short breakup length, with a relatively low pressure delta (<50 psi), and at relatively high flow rates (˜100 cc/s). The spray system may produce a relatively uniform spray inside the cylinder. The spray nozzle design may introduce small or zero dead volume, be relatively easy to manufacture, and eliminate/reduce cavitation effects.

Nozzles are known that can eject streams of water requiring a low pressure delta. Other nozzle designs are known that can eject very fine mist at a high pressure delta. However, no nozzles known appears to be able to match desired parameters.

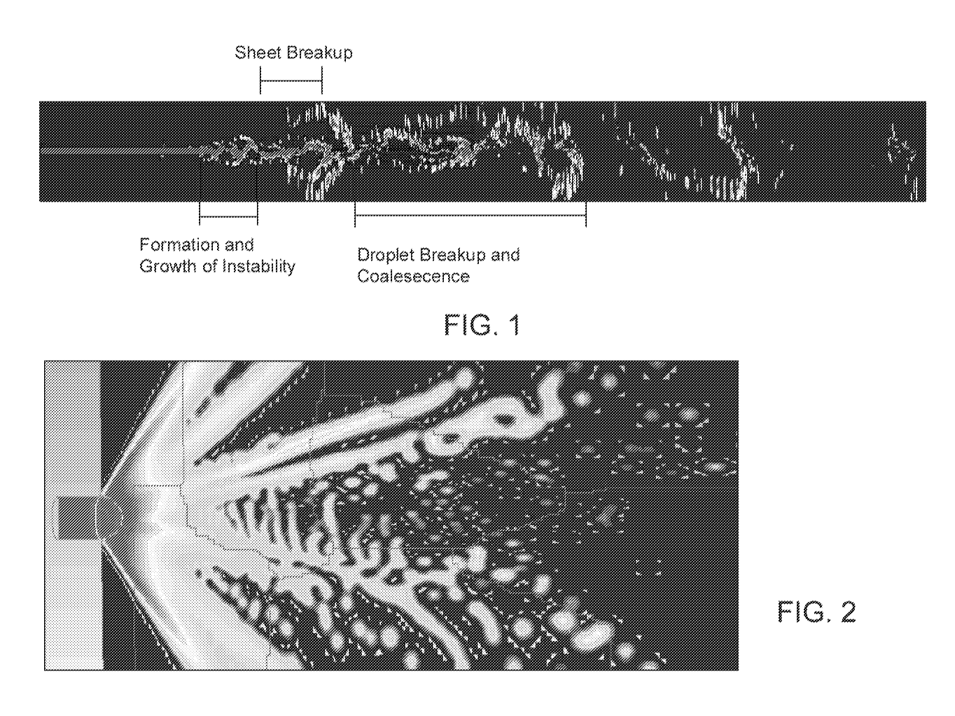

Thus, embodiments in accordance with the present invention may utilize novel nozzle designs. FIG. 1 shows a model of jet breakup from a two-dimensional CFD simulation. Red regions are for liquid and blue for air.

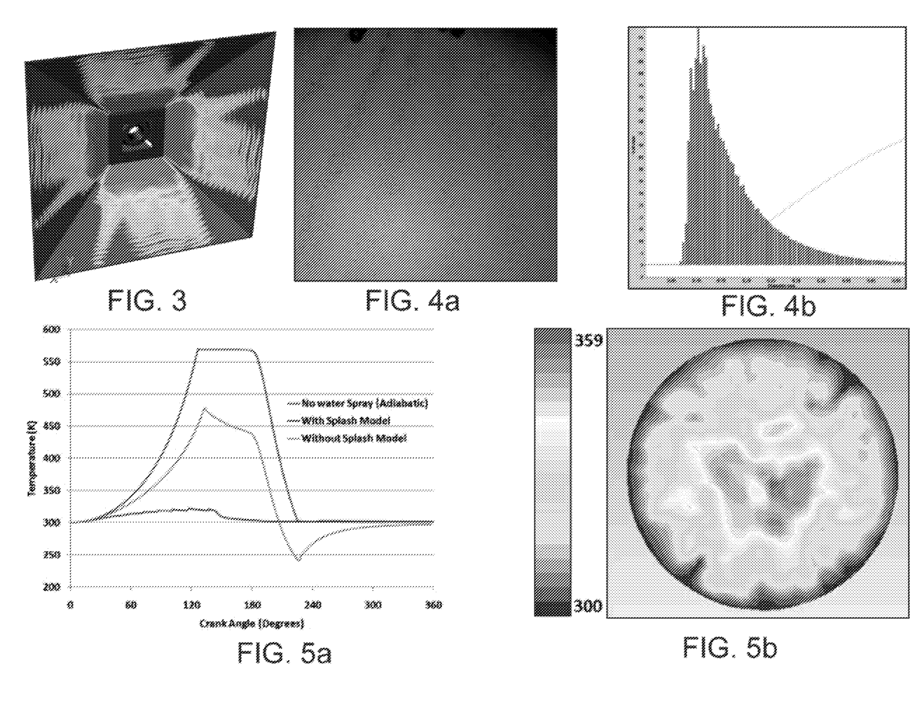

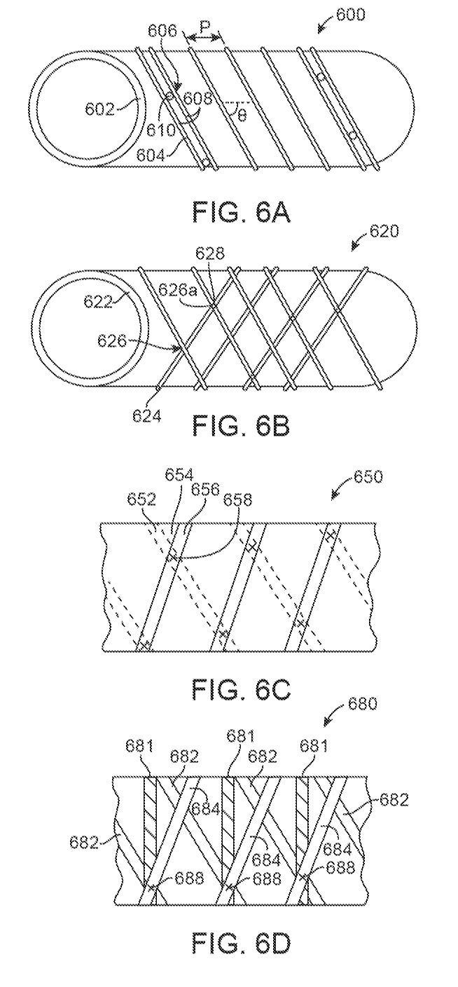

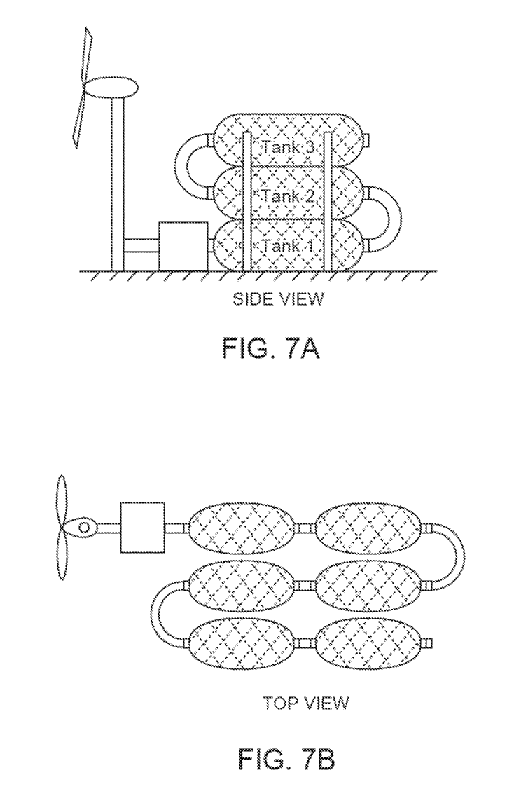

FIG. 2. shows CFD simulation of water spray emitted from a nozzle design. Red color indicates completely liquid and blue indicates air. FIG. 3 shows CFD simulation of water spray emitted from pyramid nozzle developed by LSE. Red color indicates liquid spray and blue indicates air. FIG. 4a shows liquid sheet breakup & atomization from an embodiment of a nozzle. FIG. 4b shows droplet size distribution from an embodiment of a nozzle.

Nozzle designs in accordance with embodiments of the present invention may exhibit desirable characteristics. Nozzle designs can atomize water droplets to less than 100 microns, with a pressure drop of only 50 psi, and with a high flow rate (100 cc/s) and a short breakup length (˜1 inch) that is small enough to fit in our cylinder and simple enough to replicate reliably and inexpensively.

Combination of nozzle models with a model of compression/expansion cylinder and valves, yields a full CFD model of the entire compression/expansion process. This has been used to model droplets splashing against the wall through a thin sheet of water on the surface, the mesh dynamically deforming as the piston moves and the valves open and close, and incorporating a model of the effects of droplets crowded close together, taking up an extremely high fraction of the volume available to it.

Simulation of a system with a displacement of a compression ratio of 9, and stroke taking a mere 20^{th} of a second, indicates that the average temperature of the gas without water spray would go from 300 K to 570 K. By contrast, the temperature rise in the presence of a spray of 200 micron droplets at 0.4 liters per second (20 cc's per stroke).

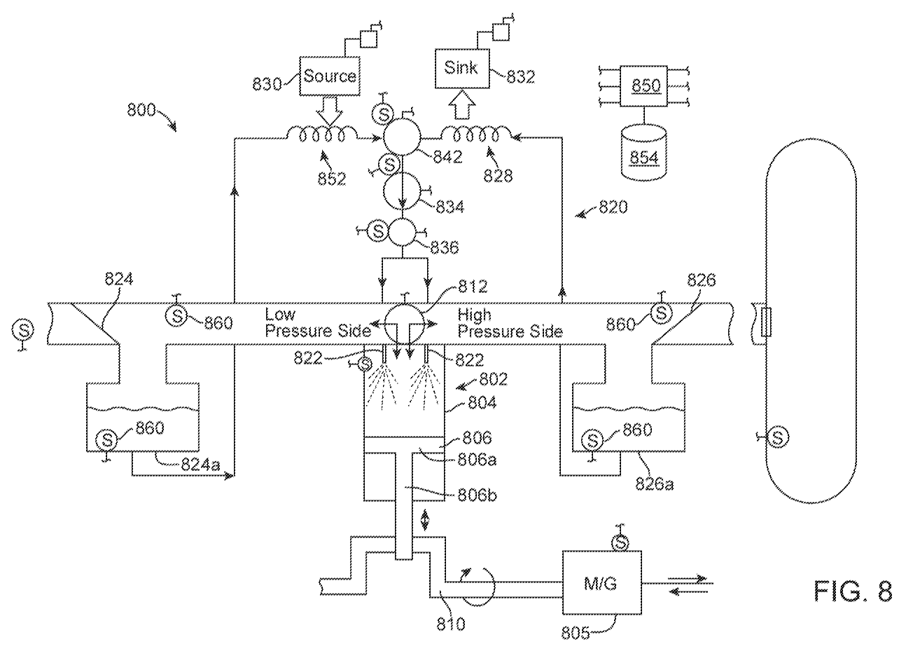

FIG. 5a indicates the mass-average air temperature in cylinder (K) versus crank rotation from CFD simulations with and without splash model. FIG. 5b indicates the temperature (K) immediately preceding opening of exhaust valve.

A thermodynamic analysis proceeded in three parts. First, the thermal behavior of a compression or expansion process was calculated, where the water was in perfect thermal equilibrium with the air, heat transfer between the mixture and the environment was negligible, and the temperatures were low enough that the saturation vapor pressure was also low, so phase-change could be neglected. The process was similar to an adiabatic compression or expansion process, with no thermal exchange between the environment and the mixture. However, the presence of water, in intimate thermal contact with the air, increases the ‘effective’ heat capacity per mole of air.

In adiabatic compression or expansion of an ideal gas, the process obeys:

pV^{γ}=constant, where:

$$γ = \frac{{c}_{p}}{{c}_{v}} = \frac{{c}_{v} + R}{{c}_{v}} ,$$

where:
cₚ and cᵥ are the molar heat capacities at constant pressure and volume, and where R is the molar gas constant.

Additionally, since pV=nRT, the temperature is given by:

$${T}_{final} = {{T}_{initial} ( \frac{{V}_{initial}}{{V}_{final}} )}^{γ - 1}$$

This is true for compression or expansion of an air and water mixture, except that y is replaced by:

$${γ}_{effective} = \frac{{c}_{v , effective} + R}{{c}_{v , effective}} ,$$

where:
C_{v,effective} is the total heat capacity of the gas and liquid at constant volume per mole of gas.

As the water spray increases in proportion, c_{v,effective} increases, and γ_{effective} approaches 1. Hence, by the expression for temperature given above, the temperature throughout the process becomes nearly constant.

A second part of the thermodynamic analysis, extended the above analytical result to account for the fact that droplets and air will not instantaneously come into thermal equilibrium. First, an equation for the maximum shaft power in or out during the process was determined. This allows finding an equation for the maximum temperature difference between the water and air ever attained during the process.

This in turn allows creation of a bounding process which can be shown to slightly overestimate the temperature change during compression or expansion. This bounding process also slightly overestimates the work required for compression, and underestimates the work done during expansion. The air and water are assumed to be continuously in thermal equilibrium, already warmed or cooled from their initial state by the maximum temperature difference attained.

This process then proceeds as the equilibrium process described above. These values depend on one another, but can be solved algebraically. This work gives us an analytical bound and scaling law on the ΔT attained during the compression and expansion process, and a lower bound on the thermodynamic efficiency.

Embodiments of systems according to the present invention may offer certain desirable properties as compared to other energy storage systems. For example, unlike batteries, cycle life of an air compressor is indefinite.

The cost of a compressed-air energy storage (CAES) system is the sum of two costs: that of the compression/expansion mechanism (a per kW cost, since this mechanism generates power), and that of the air storage system (a per kWh cost, since it stores energy). Embodiments of the present invention may target a cost of $400/kW and $80/kWh installed cost (assuming underground storage is not available). For a system with 12 hours of storage, the cost could be thought of as $113/kWh. However, a system with 26 hours of storage (the storage duration of the Macintosh, Ala. CAES plant) would cost only $95/kWh.

Reciprocating engines are a mature technology. Truck diesel engines typically cost about $100/kW. To that cost (assuming a comparable power density) a motor-generator, power electronics, and other components could be included. Meeting a $400/kW target is quite achievable for high-volume production.

Conventional steel tanks capable of storing air at 200 atmospheres cost about $125/kWh (including a valve). To this should be added the cost of a manifold, connecting hoses, an enclosure, gauges, and connectors. In addition, extra capacity is needed to account for any inefficiency in delivering power from the compressed air. If the one-way efficiency is 90%, about 1.1 kWh of storage capacity can deliver 1.0 kWh. A cost of $150/kWh may be likely for off-the-shelf technology.

If tanks are made 16 meters long, instead of their usual 1.6 meters, the cost of spinning the tank closed may be reduced, along with the cost of valves and hoses. Starting with natural gas pipeline pipe or well-casing pipe is another possible approach.

According to alternative embodiments, a target of $80/kWh target tank storage may be achieved by wrapping a thinner-walled tank with high tensile-strength fiber to create a composite material. This has the potential to reduce costs 40% or more below steel of comparable strength.

The thickness of the fibers should not pose a problem. A winding machine may include guides for multiple spools, meaning that multiple wires can be laid down in one pass.

In production, more can be added. Multifilament tows (likely untwisted to avoid loss of strength and/or stiffness, may be laid down at a higher volume rate.

One issue is to handle a stiff fiber without yielding the metal repeatedly, and thus without degrading its properties.

Another issue is to hold the fibers together after they're wound. With inorganic fibers (carbon, etc.) a polymer matrix can be used. However, polymers may not bond well to steel, and they may add 40-50% volume/mass/cost to the system.

Accordingly, embodiments of the present invention may spot braze the wire as winding occurs, for example with a robot. A volume of brazing may be less than 40%.

An amount of brazing may depend upon how much the wires are to be held together, like a basket. This involves considerations of not only preventing the wires from separating, but also preventing the wires from buckling when the pressure is released down to atm pressure.

In certain embodiments, the wires have very high ultimate, but yield below their ultimate. Embodiments according to the present invention may allow the wires to yield to use their potential, below their ultimate.

The wires may yield only the 1st time pressurization occurs, likely in a test for the vessels. Such testing may help keep the safety factor down as well, where each vessel is tested. After such a test, the wires may not be expected to yield further.

Upon de-pressurization a yielded wire recovers elastically, so it may want to buckle in compression. A wire can be held with brazing spots. This can be predicted/designed for.

The operating time at rated power can be extended indefinitely by adding more storage tanks. Enough tanks may be added to run for at least one hour (that is, about 100 kWh of total storage).

Embodiments according to the present invention may also offer a long cycle life. As a compressed air energy storage system is mechanical, not electrochemical, its performance doesn't degrade in the same way that batteries do. Properly maintained, gas compressors can run continuously for 30 years (11,000 diurnal cycles).

Embodiments according to the present invention may also offer high round-trip efficiency. Conventional CAES systems are just over 50% efficient. 80% round-trip efficiency is theoretically possible for an isothermal system. 75% efficiency under normal operation may be a more realistic target. 90% or more efficiency may be achievable if low-grade heat (such as waste heat) is available.

Efficiency in current CAES systems is limited because the heat of compression is lost. Near-isothermal operation will give thermal efficiency of close to 100%.

However, there are a number of parasitic losses that can be minimized. Examples of such parasitic losses include but are not limited to: volumetric losses (the ability to fill the cylinder with air during the intake stroke and empty it during the exhaust stroke); motor/generator efficiency; the power used to spray water into the cylinder; the heat exchanger fan; and friction. For instance, for volumetric efficiency the proper volume of water to fill most of the dead volume in the cylinder, should be maintained.

Regarding dwell time, changing from charge to discharge mode is a matter of switching the state of several valves. The engine continues rotating in the same direction. This should happen almost instantaneously.

Regarding scalability, in an embodiment a system may be on a frame that can operate at about 1 MW when all four cylinders are attached. Operation may initially be at 100 kW, but can scale up once the basic targets have been achieved.

One potential technical challenge associated with scaling up involves efficient operation at high pressures: 3000+ psi may be desirable to reduce storage footprint and cost. Maintaining a high-enough volume fraction of water at those pressures is an objective.

Still another potential benefit offered by embodiments according to the present invention is a reduction of internal losses. Specifically, existing CAES systems store compressed air underground. Depending on the type of geology used, losses can be significant. For above-ground storage in steel or composite tanks, there is, for practical purposes, zero loss in energy stored over an arbitrarily long time period.

Regarding safety, the mechanical components and pressure vessels can be fully compliant with the appropriate engineering codes. Moreover, in many embodiments the system uses no toxic substances, just air and water.

Embodiments of the present invention may last 30 years or more, typical of heavy-duty reciprocating gas compressors. As with any engine, regular maintenance is required. Piston rings, packing, filters, and lubricating oil will require periodic replacement.

Use of water in the cylinders offer a source of corrosion. Certain coatings such as DLC and other materials may provide long-term protection against corrosion.

Storage Tank Design

Embodiments of the present invention may relate to a structure for storing compressed gas an economical manner. Particular embodiments may employ a gas storage unit comprising a relatively thin liner that is wrapped with high tensile-strength filament(s) to resist the internal pressure of the compressed gas. Incorporated by reference in its entirety herein for all purposes, is the following text: Rosato and Grove, “Filament Winding: Its Development, Manufacture, Applications, and design”, New York; Interscience (1964).

A variety of different candidates for such high-tensile strength filaments are possible. One type of filament that could be used is a metal wire exhibiting high-tensile strength. In some embodiments, a filament comprising a metal alloy could be used for this purpose. Examples of metal alloys are described in the “Product Handbook of High Performance Alloys” (2008), available from Special Metals of New Hartford, New York, which is incorporated by reference herein in its entirety for all purposes.

According to certain embodiments, filaments comprising high-tensile strength steel wire could be used. In general, steel comprises an alloy of iron and carbon. Other elements can be included in steel, including but not limited to manganese, chromium, vanadium, and/or tungsten. Steel wire is available in a variety of compositions and gauges, exhibiting different properties such as tensile strength, flexibility, anneal temperature, hardness, and ductility.

Steel wire is typically formed by a cold drawing process, wherein a section is repeatedly pulled through tapered holes in a die or draw plate (block, die plate) at a relatively low temperature. Wire formed by such cold working techniques, retains a high tensile strength below its anneal temperature.

Certain embodiments may use the type of steel wire employed for musical instruments (such as piano wire), as such wire exhibits desirable elastic properties in response to applied stress. A type of steel which may be used for the filament, is set forth in the American Iron and Steel Institute (AISI) standard 1060, which describes a carbon steel comprising (in weight percentage) 0.55-0.65% Carbon (C), 0.60-0.90% Manganese (Mn), 0.04% (max) Phosphorus (P), 0.05% (max) Sulfur (S), and the base metal Iron (Fe).

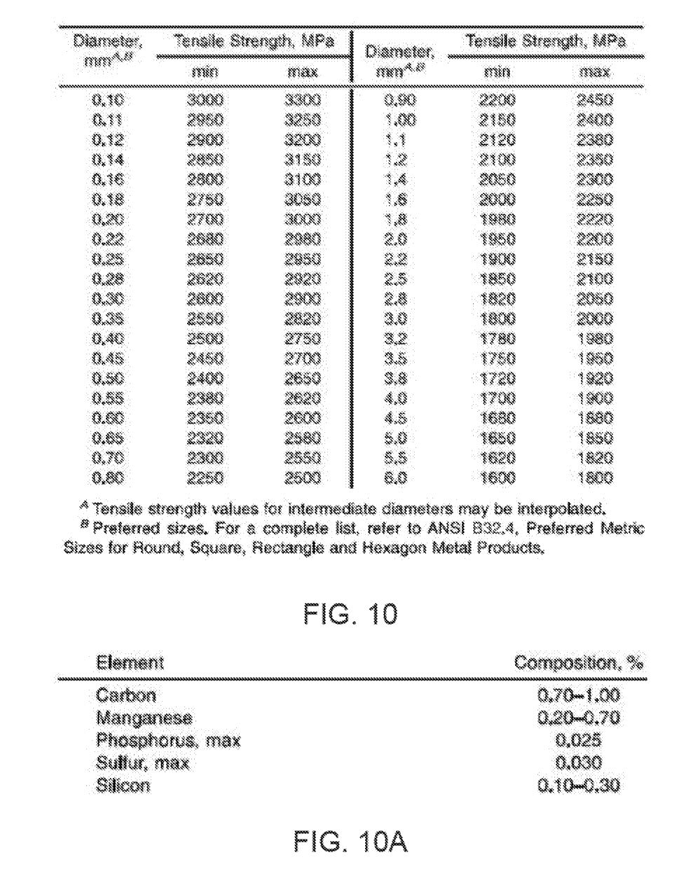

One type of steel wire that may be particularly suited for use in accordance with embodiments of the present invention, is described in the American Society for Testing and Materials (ASTM) standard A228/A228M-07 “Standard Specification for Steel Wire, Music Spring Quality”, which is incorporated herein by reference for all purposes. In particular, such steel music wire exhibits the tensile strength shown in the table of FIG. 10. The steel wire exhibits the chemical composition shown in the table of FIG. 10A.

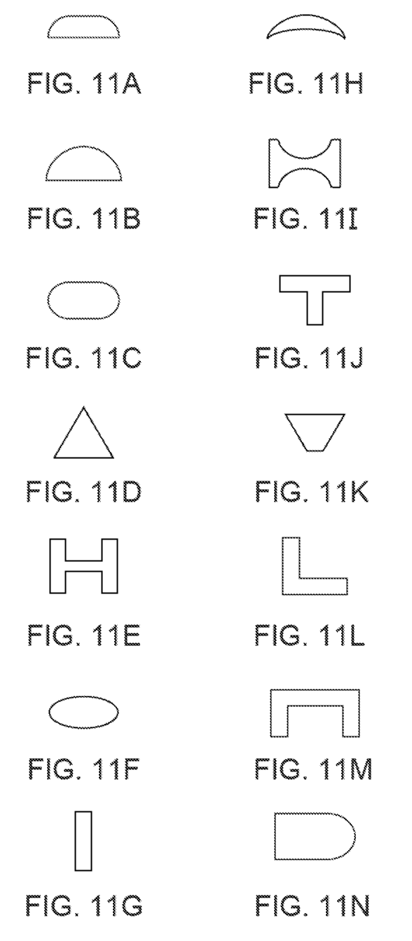

While a filament comprising a wire having a round cross-section may be used, filaments and/or filler materials of other cross-sectional shapes may be used, as is shown in FIGS. 11A-N. These cross-sectional shapes are also summarized in the following table.

| FIG. # | Cross-sectional Shape |
|---|---|
| 11A | D-shaped |
| 11B | Half-circle |
| 11C | Double D shaped |
| 11D | Triangle |
| 11E | i-beam or H-shaped |
| 11F | Oval |
| 11G | Rectangular |
| 11H | Arc-shaped |
| 11I | Hourglass |
| 11J | T-shaped |
| 11K | Wedge |
| 11L | Angular |
| 11M | Channel-shaped |
| 11N | Irregular |

One type of steel alloy wire which may be suitable for use in constructing gas storage units according to embodiments of the present invention, is sold under the trade name SCIFER. This material exhibits tensile strengths as high as 5500 MPa for small fibers, that are about 10-20× that of high-strength steel.

Conventional filament-wound pressure vessels may employ a matrix to secure the three-dimensional configuration of the wound filament in place. While some embodiments of the present invention may utilize metal secured within such a matrix, other embodiments may avoid the need for such a matrix. Instead, according to certain embodiments, the three dimensional configuration of the wound filament(s) could be secured utilizing a relatively low-temperature process such as brazing or soldering, including spot-brazing or spot-soldering in a minimum number of locations that ensures maintenance of the three-dimensional configuration of the wound filament.

Specifically, certain embodiments of the present invention may employ pressure vessels comprising metal wire filaments that are wound to a three dimensional configuration maintained by soldering or brazing the wire at selected locations along the length of the vessel. The temperatures of such soldering or brazing would likely not far exceed the anneal temperature of the metal wire, thereby preserving its original high tensile strength as imparted from cold working. In certain embodiments employing steel music wire, soldering or brazing may take place at a temperature of 400° C. or below, or even possibly at a temperature of 300° C. or below.

As used herein, the term soldering generally refers to a process in which two parts are joined together by a filler metal heated above its melting temperature. The melted filler metal flows between the parts (for example by capillary action) and then cools to fix the parts together. As referenced in the United States, a soldering process is one in which the filler metal is heated to a temperature at or below about 800° F. (427° C.). As referenced outside the United States, a soldering process takes place at or below a temperature of 450° C. (842° F.).

As used herein, the term brazing generally refers to a process that is similar to soldering, but which takes place at a higher temperature. As referenced in the United States, a brazing process is one in which the filler metal is heated to a temperature at or above about 800° F. (427° C.). As referenced outside the United States, a brazing process takes place at or above a temperature of 450° C. (842° F.).

As used herein, the term welding generally refers to a process utilizing even higher temperatures than a brazing or soldering process. In a welding process, the melting temperature of the base metal itself may be exceeded. Such a welding process may not be favored to secure a geometry of wound metal wire filament(s) according to embodiments of the present invention, as temperatures of the welding process could exceed the anneal temperature and weaken the wire.

Filler materials used in brazing or soldering processes include various alloys comprising silver, nickel, cadmium, tin, aluminum, or other metals. The filler material may be selected to have a melting point lower than an anneal temperature of the metal wire filament.

The specific three dimensional configuration in which wound filament(s) are maintained (by soldering, brazing, or other approaches), may vary. Examples of factors influencing the 3-D configuration of the wound filament include but are not limited to, the magnitude of internal forces needed to be withstood, the manner of securing together points of the 3-D configuration, and the conservation of filament and filler material in order to reduce cost.

Certain embodiments of pressure vessels according to the present invention may utilize an isotensoid geometry. In such a geometry, various portions of the three-dimensional configuration of the wound filament, experience a same amount of loading. One example of such an isotensoid geometry is an elongated cylindrical body having quasi-spherical end caps.

In portions of the pressure vessel exhibiting a cylindrical shape, the fiber may be wound at an angle of about 55° (for example 54.7°). Such an angle of winding has been demonstrated to produce optimized strength characteristics in some designs.

The use of certain winding angles may render it difficult to cover the ends of the vessel down to the boss (the vessel opening). Accordingly, some embodiments may utilize vessels having bosses of a diameter that can be covered by a particular winding angle (for example 55° winding).

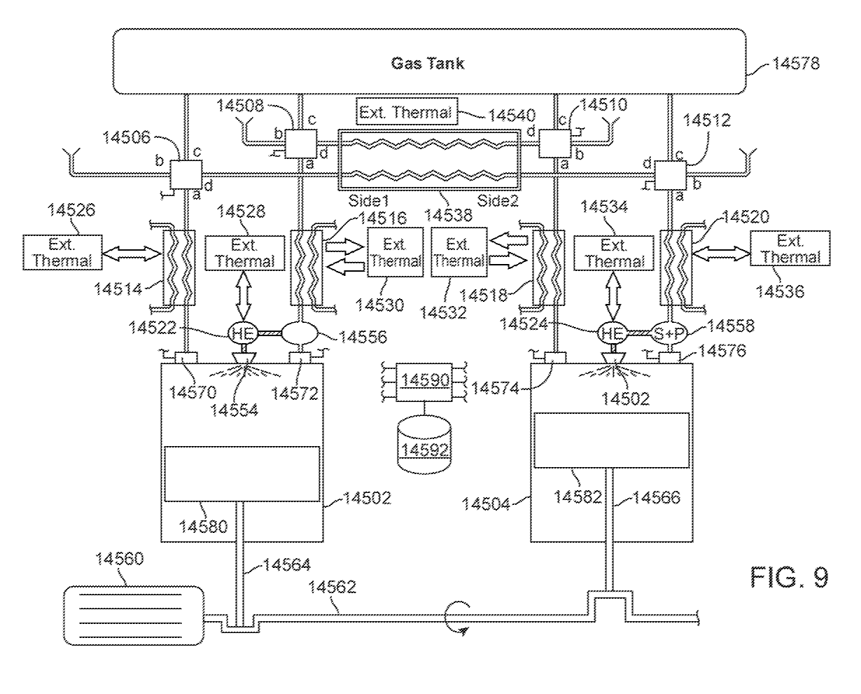

FIG. 6A shows a simplified view one embodiment of a compressed gas storage unit according to the present invention. Storage unit 600 comprises a cylindrical gas-tight liner 602 enclosed within a filament 604 that is wrapped at an angle θ and with a pitch P between adjacent coil windings. As shown in the figure, this pitch is not constant along the length of the liner.

Portions of contact 606 between adjacent windings 608 are secured together by brazing or soldering with a filler material 610. Strategic positioning of the location of the points of adjacent contact around the circumference of the storage tank, may allow for such a wound geometry to be maintained with a minimum amount of effort and expense. The location and number of such minimal points of securing, can be determined by techniques such as structural analysis, aided by a computer, to ensure integrity of the vessel while avoiding overdesign.

FIG. 6B shows another embodiment of a compressed gas storage unit in accordance with the present invention. Storage unit 620 comprises a gas-tight liner 622 that is enclosed within a filament 624 that is wound in multiple layers with portions of overlap 626 between the filaments. Selected locations of overlap 626a between multiple portions of the filament are secured together by brazing or soldering with a filler material 628. Again, strategic positioning of the points of overlap between the filament that are joined together utilizing filler material, may allow for the wound geometry to be maintained with a minimum number of points of spot-brazing or welding, in order to avoid the expense of overdesign.

While FIG. 6B shows a structure formed by the winding of a single filament, this is not required by the present invention. In alternative embodiments, a filament wound tank could be created from multiple layers formed from different wound wires that are secured together. Such multiple wires could be wound from different directions, and at different angles. The filaments may be in the form of a wire, tape, or other shape, of the same or of different thicknesses.

FIG. 6C shows yet another embodiment of a compressed gas storage unit in accordance with the present invention. Storage unit 650 comprises a gas-tight liner enclosed within a first wound layer 652 of filament. An intermediary layer 654 overlies the first wound filament layer, and a second layer 656 of filament is in turn wound over intermediary layer 654.

In certain embodiments, the intermediary layer 654 may comprise filler material. Such a configuration would avoid the need for spot welding, instead allowing global heating (for example by a furnace) followed by cooling to result in melting of the filler material, thereby forming the bonds securing the geometry of the wound structure.

In particular, global heating of the structure above the melting point of the filler material, followed by cooling, would automatically result in brazing/soldering of the wound filament layers at points of overlap 658 between the first filament layer 652 and the second filament layer 656. Such an approach would consume larger amounts of filler material, but would also result in securing the wound three-dimensional configuration at a large number of points with high strength, without requiring precise application of heat and filler material (and possibly atmosphere) typically demanded by spot soldering/brazing processes.

In the embodiment of FIG. 6C, the location of points of securing of the wound geometry, would be determined based upon the winding trajectory of the filament. This is because the filler material would be continuously present between adjacent/overlapping coils.

According to an alternative embodiment as shown in FIG. 6D, however, the amount of filler material consumed utilizing such an approach could be reduced by interposing a reduced amount of filler material in the form of a limited band having a narrow shape (such as a wire having a circular cross-section or a tape or ribbon having a cross-sectional shape for example as shown in FIGS. 11A-N) between overlapping or adjacent coils of filament. Again, a points of contact between adjacent/overlapping filament coils and the filler material, could result in local brazing/soldering based upon global heating (as could occur in a furnace) of the entire structure.

In the particular embodiment shown in FIG. 6D, global heating of the structure 680 above the melting point of the narrow band of filler material 681, followed by cooling, would automatically result in brazing/soldering of the wound filament layers 682 and 684 at points of overlap 688 with the intervening band of filler material. Such an approach would could result in securing the wound three-dimensional configuration with high strength at a select number of local points, without consuming large amounts of filler material, and without requiring the repeated precise application of heat, filler material, and possibly atmosphere, typically demanded by spot soldering/brazing processes.

In certain embodiments, filler material the form of a band (wire, ribbon, tape etc.) could itself be wound around the filament geometry. A filler material could be wound with a trajectory different from that of the filament(s), for example in a manner optimized to result in the desired number and/or location of points of contact of filler material with adjacent or overlapping coils of filament. According to some embodiments, the inherent tensile strength of such a wound band of filler material could (but need not) be relied upon to contribute additional strength.

In contrast with the embodiment of FIG. 6C, in the embodiment of FIG. 6D the location of points of securing of the wound geometry would be determined based upon both the winding trajectory of the filament, and the winding trajectory of the band of filler material. This is because both of these winding trajectories would determine places having the necessary contact between the band of filler material and overlapping filament coils.

While the embodiment of FIG. 6D shows a wound filler material present between overlapping coils of wound filament, this is not required by the present invention. According to alternative embodiments, a filler material could be provided in contact with adjacent coils of a wound filament, and remain within the scope of the present invention. In such an embodiment, the filler material could overlie or underlie the adjacent filament coils.

Moreover, in some embodiments the filler material need not be wound, but could simply be placed into contact with the wound filament(s) prior to brazing or soldering. In certain embodiments the filler material could be secured into place, for example through the use of adhesives or by a constricting effect of an overlying coil of the wound filament.

Apart and/or in addition to serving as a filler material for a brazing or soldering process, an intermediary layer present between layers of wound filament could serve other functions. One role is to serve as a further airtight barrier to prevent escape of compressed gas held within the liner.

As shown previously, the filament wound pressure vessel may exhibit a geometry in the form of a simple cylinder having domed end caps. However, the present invention is not limited to such a structure, and alternative embodiments may feature different geometries, including but not limited to circular toroidal.

The precise secured three-dimensional configuration exhibited by the wound filament(s) may be determined by a number of parameters. In certain embodiments, the three-dimensional configuration may be based upon geodesic winding principles, where geodesic refers to the shortest paths connecting any two points on a continuous surface.

In other embodiments, however, the wound geometry may be based upon other than geodesic winding principles. For example, the use of non-geodesic fiber trajectories for a toroidal-shaped compressed gas storage unit, is described by Lei Zu et al., in “Design of filament-wound circular toroidal hydrogen storage vessels based on non-geodesic fiber trajectories”, International Journal of Hydrogen Energy, vol. 35 Issue 2 pp. 660-670 (January 2010), which is incorporated by reference in its entirety herein for all purposes. The use of non-geodesic fiber trajectories for a pressure vessel having asymmetrical openings is described by Lei Zu et al. in “Design of filament-wound isotensoid pressure vessels with unequal polar openings”, Composite Structures, Vol. 92 pp. 2307-2313 (2010), which is also incorporated by reference in its entirety herein for all purposes.

In various embodiments, properties of a wound filament such as an angle of winding, filament diameter or geometry, or a pitch between adjacent coils, need not be the same as between other layers of wound filament(s). Moreover, parameters such as an angle of winding, and a pitch of winding, need not be uniform within a single layer of wound filament. And in certain embodiments, multiple layers of filament(s) could be employed (including secured and unsecured points of overlap), with intermediary layer(s) (which may or may not comprise filler material) positioned between filament layers.

According to certain embodiments, the local application of heat associated with spot welding or brazing may lower the tensile strength of the metal wire. Such reduced strength in restricted locations could be compensated for in any one of a variety of ways, including but not limited to decreasing the pitch of the coils of wound filament, changing an angle of winding of the filament, and/or designing the three-dimensional configuration of the wound filament to provide additional physical support. One such configuration is shown in the embodiment of FIG. 6A, where the wound coils are spaced closer together at the points of adjacent contact fixed with spot brazing or soldering.

The liner of a filament-wound pressure vessel according to embodiments of the present invention, may be formed from a variety of materials. Examples include plastics or rubber or metal. While in some embodiments the liner may be completely gas-tight, alternative embodiments may utilize a liner allowing some gas leakage. The effect of such leakage may be compensated for by advantages in cost or other factors, and/or may be counteracted by another structure such as an intermediary layer or an outer sleeve or coating.

Previous designs for filament wound pressure vessels have focused on ensuring sufficient strength in the face of acute localized forces arising from specific geometries, for example those present in the confined domed end portions of a cylindrical vessel. Embodiments of the present invention can provide the bulk strength to resist internal pressure at a low cost along a lengthy body, thereby freeing resources for the design of end fixtures specially adapted to withstand concentrated force arising from geometrical constraints.

According to certain embodiments, the end fixtures of cylindrically-shaped storage units could include features such as flanges and/or threads to facilitate connection with another storage unit, thereby allowing storage capacity to be expanded or reduced in a modular manner. In certain embodiments the connections between successive storage units could have a particular shape, to allow arrangement of the tanks in compact serpentine or folded configurations.

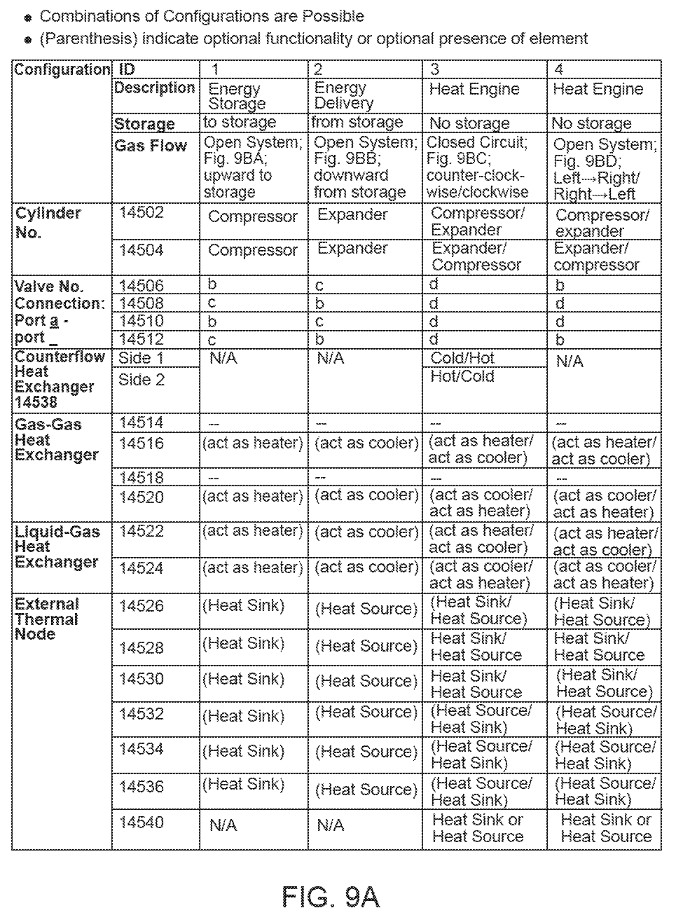

For example, FIG. 7A shows a side elevational view of a configuration utilizing a vertical folded configuration for pressure vessels. FIG. 7B shows a plan view of a configuration utilizing a serpentine horizontal folded configuration. Such configurations may employ elbow-type conduits. As used herein the term elbow is not limited to a shape exhibiting any particular angle (such as 90°), but instead encompasses a conduit whose main axis experiences a change in direction along its length.

Elbow-type conduits themselves may also be fabricated utilizing bulk material (such as steel or another metal), or may be fabricated utilizing composite materials such as filament-wound designs. Examples of elbow-type conduits utilizing filament winding principles, are described by Li and Liang in “Computer aided filament winding for elbows”, J. Software, Vol. 13(4), pp. 518-25 (2002), which is incorporated by reference in its entirety herein for all purposes.

Embodiments of gas storage units according to the present invention may be fabricated to conform to certain form factors. For example, particular embodiments may be sized to fit within a storage container, within a rail car, or within a tractor trailer of standard dimensions.

The strength of the points of securing of the three-dimensional configuration of wound filament, may be determined at least in part by forces other than the internal force exerted by the pressurized gas. In particular, the brazing or soldering serving only to maintain the wound configuration, with the tensile strength of the wound filament serving to resist internal pressures.

An amount of brazing or soldering may depend upon considerations of not only preventing the wires from separating from the wound geometry in response to internal pressure, but also preventing the wires from buckling when the pressure is released.

Specifically, pressure vessels utilized for energy storage may experience depressurization as the compressed gas is flowed out for expansion and prior to replenishment. Upon such depressurization, a wire of the wound geometry that has previously yielded, may recover its shape elastically and thereby experience buckling in compression. In order to resist such buckling, a wire can be held in place by brazing with another wire.

Certain embodiments may employ metals having a very high ultimate strength, but which yield below their ultimate strength. Thus some embodiments may allow the wires to yield to use their potential, below their ultimate strength.

Some embodiments may be designed with the expectation that the wires may yield only the first time pressurization occurs, as in a test procedure. Such individual processing may also serve to reduce the safety factor, as each vessel is tested under the expected internal pressure. After such pressure testing, the wires may not be expected to yield further.

The design and/or fabrication of certain embodiments of the present invention, may involve the use of structural analysis (static and dynamic) and/or finite element analysis. Detailed stress analysis, testing, and probabilistic methods can be employed in place of large safety factors, thus maximizing vessel integrity and safety while minimizing overdesign.

While the above description has focused upon a gas storage unit wound with a high tensile strength metal fiber such as a steel wire, this is not required by the present invention. According to alternative embodiments, other types of wound filaments may be utilized. Examples of such alternative types of filaments include but are not limited to fiberglass, carbon fiber, and basalt.

As used herein, basalt refers to solid rock material formed from solidified lava flows. Natural basalt may be processed to create fibers of different characteristics, including length and cross-sectional area.

Basalt fibers may exhibit a number of desirable properties. For example, basalt fibers possess high physical durability. The strength-to-weight ratio of a basalt fiber may exceed a strength of alloyed steel by 2.5 times, and exceed the strength of fiber glass by 1.5 times.

Basalt fibers may also exhibit high chemical durability upon exposure to water, salts, alkalis, and acids. Unlike metal, basalt is not affected by corrosion. Unlike fiber glass, basalt is not affected by acids. Basalt possesses high corrosion and chemical durability qualities towards corrosive mediums such as salts and acidic and alkali solutions.

Once the filaments are wound, they are secured together in a geometry to exhibit a strength necessary to resist the internal pressure. Where the fibers are composed by a non-metal material (such as basalt), a polymer matrix can be used to secure a filament geometry. In certain embodiments, a polymer matrix may also exhibit sufficient adhesion to a metal to secure the geometry of wound metal filament(s).

Basalt fibers exhibit a relatively high stiffness. Owing to this high stiffness property, wound geometries of basalt fibers could be secured utilizing an inexpensive matrix material. One example of an inexpensive polymer matrix that could be used in conjunction with basalt fibers, is isophthalic polyester.

1. A pressure vessel comprising:

a liner enclosing a space having a substantially circular cross-section along a length; and a filament comprising a metal wire wrapped around the liner to form a three-dimensional configuration maintained by joining the metal wire at points along the length.

2. A pressure vessel as in claim 1 wherein the metal wire comprises steel joined by filler material between overlapping coils.

2a. A pressure vessel as in claim 1 or 2 wherein the metal wire comprises AISI 1060 steel.

3. A pressure vessel as in claim 2 wherein the filler material is present as a band between the overlapping coils.

4. A pressure vessel as in claim 3 wherein the band of filler material is wound.

5. A pressure vessel as in claim 2 wherein the filler material is present as a continuous intermediate layer between the overlapping coils.

6. A pressure vessel as in claim 2 wherein the filler material is present as a result of a spot-soldering or spot-brazing process.

7. A pressure vessel as in claim 1 wherein the metal wire comprises steel joined by filler material between adjacent coils.

7a. A pressure vessel as in claim 7 wherein the metal wire comprises AISI 1060 steel.

8. A pressure vessel as in claim 7 wherein the filler material is present as a band in contact with the adjacent coils.

9. A pressure vessel as in claim 8 wherein the band of filler material is wound.

10. A pressure vessel as in claim 7 wherein the filler material is present as a continuous intermediate layer in contact with the adjacent coils.

11. A pressure vessel as in claim 7 wherein the filler material is present as a result of a spot-soldering or spot-brazing process.

12. A pressure vessel as in any of claims 1-11 wherein a number of the points is limited to avoid overdesign.

13. A pressure vessel as in any of claims 1-12 wherein the metal wire is joined utilizing a filler material melted in a brazing process.

14. A pressure vessel as in any of claims 1-12 wherein the metal wire is joined utilizing a filler material melted in a soldering process.

15. A pressure vessel as in any of claims 1-14 wherein the liner comprises plastic material.

16. A pressure vessel as in any of claims 1-15 wherein the metal wire exhibits a geodesic winding.

17. A pressure vessel as in any of claims 1-15 wherein the metal wire exhibits other than a geodesic winding.

18. A pressure vessel as in any of claims 1-17 wherein the metal wire is wrapped at an angle of approximately 55°.

19. A pressure vessel as in any of claims 1-17 wherein the space comprises a cylinder having quasi-spherical ends.

20. A pressure vessel as in any of claims 1-19 wherein the three-dimensional configuration is isotensoid upon pressurization of the space.

21. A pressure vessel as in any of claims 1-19 wherein the three-dimensional configuration is other than isotensoid upon pressurization of the space.

22. A pressure vessel as in any of claims 1-21 wherein the metal wire comprises steel music wire.

23. A pressure vessel as in claim 22 wherein the steel music wire conforms to ASTM specification A228/A228M-07.

24. A method of fabricating a pressure vessel, the method comprising: winding a metal wire in coils around a gastight liner; and

joining the metal wire at points along its length by brazing or soldering below an anneal temperature of the metal wire.

25. A method as in claim 24 wherein the joining comprises introducing a filler material between overlapping coils.

26. A method as in claim 25 wherein the filler material is present as a band in contact with the overlapping coils.

27. A method as in claim 26 wherein the band of filler material is wound.

28. A method as in claim 25 wherein the filler material is present as a continuous intermediate layer between the overlapping coils.

29. A method as in any of claims 25-28 wherein joining the metal wire comprises global heating of the metal wire and the filler material below the anneal temperature.

30. A method as in any of claims 24-28 wherein joining the metal wire comprises local heating as part of a spot-soldering or spot-brazing process.

31. A method as in claim 24 wherein the joining comprises introducing a filler material between adjacent coils.

32. A method as in claim 31 wherein the filler material is present as a band in contact with the adjacent coils.

33. A method as in claim 32 wherein the band of filler material is wound.

34. A method as in claim 31 wherein the filler material is present as a continuous intermediate layer in contact with the adjacent coils.

35. A method as in any of claims 31-34 wherein joining the metal wire comprises global heating of the metal wire and filler material below the anneal temperature.

36. A method as in any of claim 24 or 31-34 wherein joining the metal wire comprises local heating as part of a spot-soldering or spot-brazing process.

37. A method as in any of claims 24-36 wherein a number of the points is limited to avoid overdesign.

38. A method as in any of claims 24-37 wherein the winding comprises a geodesic winding.

39. A method as in any of claims 24-37 wherein the winding comprises other than a geodesic winding.

40. A method as in any of claims 24-39 wherein the metal wire comprises AISI 1060 steel.

41. A method as in any of claims 24-40 wherein the metal wire comprises steel music wire.

42. A method as in claim 41 wherein the steel music wire conforms to ASTM specification A228/A228M-07.

As described above, embodiments of gas storage units according to the present invention may be suited to work in conjunction with compressed gas energy systems. Various embodiments of such energy recovery systems are described in the U.S. patent application Ser. No. 13/010,683 filed Jan. 20, 2011, which is incorporated by reference in its entirety herein for all purposes. This document shows a number of embodiments of compressed gas energy storage systems, including systems utilizing multiple successive expansion and/or compression stages.

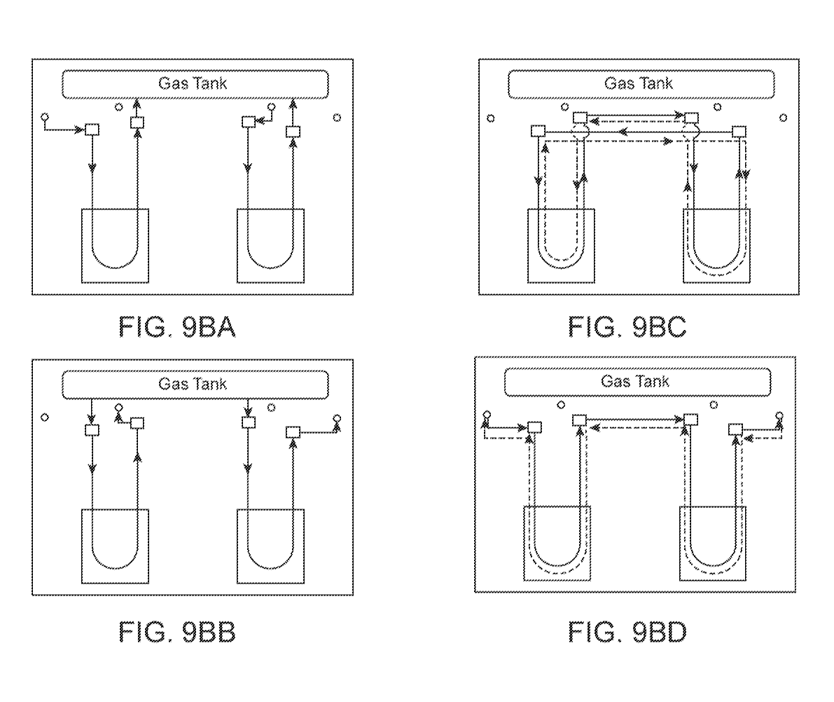

FIG. 8 shows a simplified view of one embodiment of such a compressed gas energy system. In particular, the system 800 includes a compressor/expander 802 comprising a cylinder 804 having piston 806 moveably disposed therein. The head 806a of the piston is in communication with a motor/generator 808 through a piston rod 806b and a linkage 810 (here a crankshaft).

In a compression mode of operation, the piston may be driven by the motor/generator 805 acting as a motor to compress gas within the cylinder. The compressed gas may be flowed to a gas storage tank 870, or may be flowed to a successive higher-pressure stage for additional compression.

In an expansion mode of operation, the piston may be moved by expanding gas within the cylinder to drive the motor/generator acting as a generator. The expanded gas may be flowed out of the system, or flowed to a successive lower-pressure stage for additional expansion.

The cylinder is in selective fluid communication with a high pressure side or a low pressure side through valving 812. In this particular embodiment, the valving is depicted as a single multi-way valve. However, the present invention is not limited to such a configuration, and alternatives are possible.

For example, in lieu of a single, multi-way valve, some embodiments of the present invention may include the arrangement of multiple one-way, two-way, or three-way valves in series. Examples of valve types which could be suitable for use in accordance with embodiments of the present invention include, but are not limited to, spool valves, gate valves, cylindrical valves, needle valves, pilot valves, rotary valves, poppet valves (including cam operated poppet valves), hydraulically actuated valves, pneumatically actuated valves, and electrically actuated valves (including voice-coil actuated valves).

Certain embodiments may employ gas flow valves as have been employed in steam engine design. Examples of such valves include slide valves (such as D valves), Corliss valves, and others as are described by Joshua Rose, M. E, in Modern Steam Engines, Henry Carey Baird & Co., Philadelphia, Pa. (1887), reprinted by Astragal Press (2003), which is incorporated by reference in its entirety herein for all purposes.

When operating in the compression mode, gas from the low pressure side is first flowed into the cylinder, where it is compressed by action of the piston. The compressed gas is then flowed out of the cylinder to the high pressure side.

When operating in the expansion mode, gas from the high pressure side is flowed into the cylinder, where its expansion drives the piston. The expanded gas is subsequently exhausted from the cylinder to the low pressure side.

Embodiments of the present invention utilize heat exchange between liquid and gas that is undergoing compression or expansion, in order to achieve certain thermodynamic efficiencies. Accordingly, the system further includes a liquid flow network 820 that includes pump 834 and valves 836 and 842.

The liquid flow network is configured to inject liquid into the cylinder to perform heat exchange with expanding or compressing gas. In this embodiment, the liquid is introduced through nozzles 822. In other embodiments, a bubbler may be used, with the gas introduced as bubbles through the liquid.

The liquid that has been injected into the cylinder to exchange heat with compressed gas or expanding gas, is later recovered by gas-liquid separators 824 and 826 located on the low- and high-pressure sides respectively. Examples of gas-liquid separator designs include vertical type, horizontal type, and spherical type. Examples of types of such gas-liquid separators include, but are not limited to, cyclone separators, centrifugal separators, gravity separators, and demister separators (utilizing a mesh type coalescer, a vane pack, or another structure).

Liquid that has been separated may be stored in a liquid collector section (824a and 826a respectively). A liquid collector section of a separator may include elements such as inlet diverters including diverter baffles, tangential baffles, centrifugal, elbows, wave breakers, vortex breakers, defoaming plates, stilling wells, and mist extractors.

The collected separated liquid is then thermally conditioned for re-injection. This thermal conditioning may take place utilizing a thermal network. Examples of components of such a thermal network include but are not limited to liquid flow conduits, gas flow conduits, heat pipes, insulated vessels, heat exchangers (including counterflow heat exchangers), loop heat pipes, thermosiphons, heat sources, and heat sinks.

For example, in an operational mode involving gas compression, the heated liquid collected from gas-liquid separator 826 is flowed through heat exchanger 828 that is in thermal communication with heat sink 832. The heat sink may take one of many forms, including an artificial heat sink in the form of a cooling tower, fan, chiller, or HVAC system, or natural heat sinks in the form of the environment (particularly at high latitudes or altitudes) or depth temperature gradients extant in a natural body of water.

In an operational mode involving gas expansion, the cooled liquid collected from gas-liquid separator 824 is flowed through heat exchanger 852 that is in thermal communication with heat source 830. Again, the heat source may be artificial, in the form of heat generated by industrial processes (including combustion) or other man-made activity (for example as generated by server farms). Alternatively, the heat source may be natural, for example geothermal or solar in nature (including as harnessed by thermal solar systems).

Flows of liquids and/or gases through the system may occur utilizing fluidic and/or pneumatic networks. Examples of elements of fluidic networks include but are not limited to tanks or reservoirs, liquid flow conduits, gas flow conduits, pumps, vents, liquid flow valves, gas flow valves, switches, liquid sprayers, gas spargers, mixers, accumulators, and separators (including gas-liquid separators and liquid-liquid separators), and condensers. Examples of elements of pneumatic networks include but are not limited to pistons, accumulators, gas chambers liquid chambers, gas conduits, liquid conduits, hydraulic motors, hydraulic transformers, and pneumatic motors.

As shown in FIG. 8, the various components of the system are in electronic communication with a central processor 850 that is in communication with non-transitory computer-readable storage medium 854, for example relying upon optical, magnetic, or semiconducting principles. The processor is configured to coordinate operation of the system elements based upon instructions stored as code within medium 854.

The system also includes a plurality of sensors 860 configured to detect various properties within the system, including but not limited to pressure, temperature, volume, humidity, and valve state. Coordinated operation of the system elements by the processor may be based at least in part upon data gathered from these sensors.

The particular system shown in FIG. 8 represents only one particular embodiment, and alternatives having other features are possible. For example, while FIG. 8 shows an embodiment with compression and expansion occurring in the same cylinder, with the moveable element in communication with a motor/generator, this is not required.

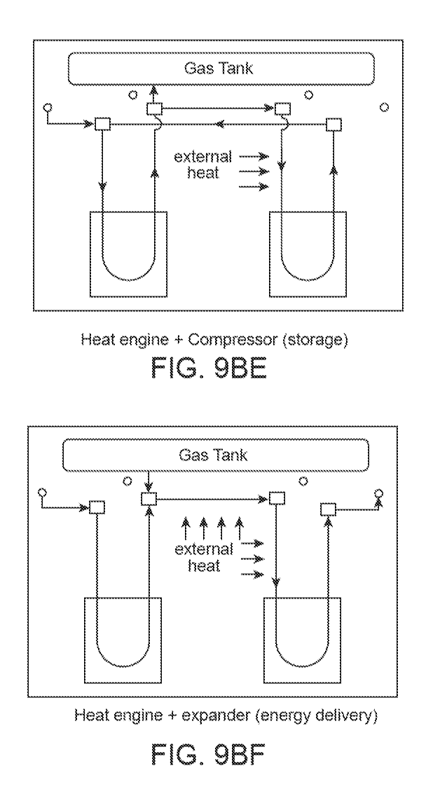

FIG. 9 shows an alternative embodiment utilizing two cylinders, which in certain modes of operation may be separately dedicated for compression and expansion. Embodiments employing such separate cylinders for expansion and compression may, or may not, utilize a common linkage (here a mechanical linkage in the form of a rotating crankshaft) with a motor, generator, or motor/generator.

For example, FIG. 9A is a table showing four different basic configurations of the apparatus of FIG. 9. The table of FIG. 9A further indicates the interaction between system elements and various thermal nodes 14625, 14528, 14530, 14532, 14534, 14536, and 14540, in the different configurations. Such thermal nodes can comprise one or more external heat sources, or one or more external heat sinks, as indicated more fully in that table. Examples of such possible such external heat sources include but are not limited to, thermal solar configurations, geothermal phenomena, and proximate heat-emitting industrial processes. Examples of such possible such external heat sinks include but are not limited to, the environment (particularly at high altitudes and/or latitudes), and geothermal phenomena (such as snow or water depth thermal gradients).

FIGS. 9BA-9BD are simplified views showing the various basic operational modes listed in FIG. 9A. The four different basic modes of operation shown in FIG. 9A may be intermittently switched, and/or combined to achieve desired results. FIGS. 9BE-BF show operational modes comprising combinations of the basic operational modes.

One possible benefit offered by the embodiment of FIG. 9 is the ability to provide cooling or heating on demand. Specifically, the change in temperature experienced by an expanding or compressed gas, or an injected liquid exchanging heat with such an expanding or compressed gas, can be used for temperature control purposes. For example, gas or liquid that is cooled by expansion, could be flowed to a building HVAC system. Conversely, the increase in temperature experienced by a compressed gas, or a liquid exchanging heat with a compressed gas, can be used for heating.

By providing separate, dedicated cylinders for gas compression or expansion, embodiments according to FIG. 9 may provide such temperature control on-demand, without reliance upon a previously stored supply of compressed gas. In particular, the embodiment of FIG. 9 allows cooling based upon immediate expansion of gas compressed by the dedicated compressor.

While FIGS. 8-9 show embodiments involving the movement of a solid, single-acting piston, this is not required. Alternative embodiments could utilize other forms of moveable elements. Examples of such moveable elements include but are not limited to double-acting solid pistons, liquid pistons, flexible diaphragms, screws, turbines, quasi-turbines, multi-lobe blowers, gerotors, vane compressors, and centrifugal/axial compressors. Where a solid piston is used, a piston rod and/or crosshead may also be employed.

Moreover, embodiments may communicate with a motor, generator, or motor/generator, through other than mechanical linkages. Examples of alternative linkages which may be used include but are not limited to, hydraulic/pneumatic linkages, magnetic linkages, electric linkages, and electro-magnetic linkages.

While the particular embodiments of FIGS. 8-9 show a piston in communication with a motor generator through a mechanical linkage in the form of a crankshaft, this is not required. Alternative embodiments could utilize other forms of mechanical linkages, including but not limited to gears such as multi-node gearing systems (including planetary gear systems). Examples of mechanical linkages which may be used include shafts such as crankshafts, gears, chains, belts, driver-follower linkages, pivot linkages, Peaucellier-Lipkin linkages, Sarrus linkages, Scott Russel linkages, Chebyshev linkages, Hoekins linkages, swashplate or wobble plate linkages, bent axis linkages, Watts linkages, track follower linkages, and cam linkages. Cam linkages may employ cams of different shapes, including but not limited to sinusoidal and other shapes. Various types of mechanical linkages are described in Jones in “Ingenious Mechanisms for Designers and Inventors, Vols. I and II”, The Industrial Press (New York 1935), which is hereby incorporated by reference in its entirety herein for all purposes.

In certain embodiments of the present invention, it may be important to control the amount of liquid introduced into the chamber to effect heat exchange. The ideal amount may depends on a number of factors, including the heat capacities of the gas and of the liquid, and the desired change in temperature during compression or expansion.

The amount of liquid to be introduced may also depend on the size of droplets formed by the spray nozzle. One measure of the amount of liquid to be introduced, is a ratio of the total surface area of all the droplets, to the number of moles of gas in the chamber. This ratio, in square meters per mole, could range from about 1 to 250 or more. Examples of this ratio which may be suitable for use in embodiments of the present invention include 1, 2, 5, 10, 15, 25, 30, 50, 100, 125, 150, 200, or 250.

Embodiments of spray nozzles according to the present invention may exhibit particular performance characteristics. Examples of performance characteristics include breakup length, spray pattern, spray cone angle, fan angle, angle to surface (for fan sprays), and droplet spatial distribution.

One performance characteristic is droplet size. Droplet size may be measured using DV50, Sauter mean diameter (also called SMD, D32, d₃₂ or D[3, 2]), or other measures. Embodiments of nozzles according to the present invention may produce liquid droplets having SMD's within a range of between about 10-200 um. Examples of droplet sizes produced by embodiments of nozzles according to the present invention include but are not limited to those having a SMD of about 200 microns, 150 microns, 100 microns, 50 microns, 25 microns, and 10 microns.

Another performance characteristic of liquid spray nozzles according to embodiments of the present invention, is flow rate. Embodiments according to the present invention may produce a flow rate of between about 20 and 0.01 liters per second. Examples of flow rates of embodiments of nozzles according to the present invention are 20, 10, 5, 2, 1, 0.5, 0.25, 0.1, 0.05, 0.02, and 0.01 liters per second.

Another performance characteristic of liquid spray nozzles according to embodiments of the present invention, is breakup length. Liquid output by embodiments of nozzles according to the present invention may exhibit a breakup length of between about 1-100 mm. Examples of breakup lengths of sprays of liquid from nozzles according to the present invention include 100, 50, 25, 10, 5, 2, and 1 mm.

Embodiments of nozzles according to the present invention may produce different types of spray patterns. Examples of spray patterns which may be produced by nozzle embodiments according to the present invention include but are not limited to, hollow cone, solid cone, stream, single fan, and multiple fans.

Embodiments of nozzles according to the present invention may produce spray cone angles of between about 20-180 degrees. Examples of such spray cone angles include but are not limited to 20°, 22.5°, 25°, 30°, 45°, 60°, 90°, 120°, 150°, and 180°.

Embodiments of nozzles according to the present invention may produce spray fan angles of between about 20-360 degrees. Examples of such fan angles include but are not limited to 20°, 22.5°, 25°, 30°, 45°, 60°, 90°, 120°, 150°, 180°, 225°, 270°, 300°, 330°, or 360°. Examples of fan spray angles to surface possibly produced by embodiments of the present invention, include but are not limited to 90°, 80°, 60°, 45°, 30°, 22.5°, 20°, 15°, 10°, 5°, or 0°.

Droplet spatial distribution represents another performance characteristic of liquid spray nozzles according to embodiments of the present invention. One way to measure droplet spatial distribution is to measure the angle of a sheet or cone cross-section that includes most of the droplets that deviate from the sheet. In nozzle designs according to embodiments of the present invention, this angle may be between 0-90 degrees. Examples of such angles possibly produced by embodiments of the present invention include but are not limited to 0°, 1°, 2°, 5°, 7.5°, 10°, 15°, 20°, 25°, 30°, 45°, 60°, 75°, or 90°.

Certain nozzle designs may facilitate the fabrication of individual nozzles. Certain nozzle designs may also permit the placement of a plurality of nozzles in a given surface proximate to one another, which can enhance performance.

In particular embodiments, sprays of liquid from two or even more of the nozzles may overlap with each other in certain regions. This overlap creates the potential that the liquid spray droplets will collide with each other, thereby further breaking them up into smaller sizes for heat exchange.

Nozzles may be positioned on one or more surfaces within a cylinder. Nozzles may be positioned to inject liquid in directions substantially parallel to, or orthogonal to, directions of motion of a moveable member within a chamber, and/or directions of gas inlet into a chamber.

The flexibility in fabrication and placement of a plurality of spray nozzles, may offer additional enhancements to performance. For example, in certain embodiments the orientation of the dimensional axis of spray structures relative to a direction of piston movement and/or a direction of gas inflow, may be uniform or non-uniform relative to other spray structures.

Thus in certain embodiments, the dimensional axis of the spray structures could each be offset from a gas flow direction in a consistent manner, such that they combine to give rise to a bulk effect such as swirling. In other embodiments, the dimensional axis of the spray structures could be oriented in a non-uniform relative to certain direction, in a manner that is calculated to promote interaction between the gas and the liquid droplets. Such interaction could enhance homogeneity of the resulting mixture, and the resulting properties of the heat exchange between the gas and liquid of the mixture.

In certain embodiments, one or more spray nozzles may be intentionally oriented to direct a portion of the spray to impinge against the chamber wall. Such impingement may serve to additionally break up the spray into smaller droplets over a short distance.

1. A pressure vessel comprising:
a liner enclosing a space having a substantially circular cross-section along a length; and
a filament comprising a metal wire wrapped around the liner to form a three-dimensional configuration maintained by joining the metal wire at points along the length.

2. A pressure vessel as in claim 1 wherein the metal wire comprises steel joined by filler material between overlapping coils.

3. A pressure vessel as in claim 2 wherein the filler material is present as a band between the overlapping coils.

4. A pressure vessel as in claim 3 wherein the band of filler material is wound.

5. (canceled)

6. A pressure vessel as in claim 2 wherein the filler material is present as a result of a spot-soldering or spot-brazing process.

7. A pressure vessel as in claim 1 wherein the metal wire comprises steel joined by filler material between adjacent coils.

8. A pressure vessel as in claim 7 wherein the filler material is present as a band in contact with the adjacent coils.

9. A pressure vessel as in claim 8 wherein the band of filler material is wound.

10. (canceled)

11. A pressure vessel as in claim 7 wherein the filler material is present as a result of a spot-soldering or spot-brazing process.

12. A pressure vessel as in claim 1 wherein a number of the points is limited to avoid overdesign.

13. A pressure vessel as in claim 1 wherein the metal wire is joined utilizing a filler material melted in a brazing process or in a soldering process.

14. (canceled)

15. A pressure vessel as in claim 1 wherein the liner comprises plastic material.

16. A pressure vessel as in claim 1 wherein the metal wire exhibits a geodesic winding.

17. A pressure vessel as in claim 1 wherein the metal wire exhibits other than a geodesic winding.

18. A pressure vessel as in claim 1 wherein the metal wire is wrapped at an angle of approximately 55°.

19. A pressure vessel as in claim 1 wherein the space comprises a cylinder having quasi-spherical ends.

20. A pressure vessel as in claim 1 wherein the three-dimensional configuration is isotensoid upon pressurization of the space.

21. (canceled)

22. A pressure vessel as in claim 1 wherein the metal wire comprises steel music wire.

23. A pressure vessel as in claim 22 wherein the steel music wire conforms to ASTM specification A228/A228M-07.

24. A pressure vessel as in claim 1 wherein the metal wire comprises AISI 1060 steel.
